(19) United States
(12) Patent Application Publication
(10) Pub. No.: US 2005/0241112 A1
(43) Pub. Date: Nov. 3, 2005

(54) Method of making polymeric knob and polymeric knob made thereby

(75) Inventor: James L. Worrell, DeKalb, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: K l Industries, Inc.

(21) Appl. No.: 11/178,646

(22) Filed: Jul. 11, 2005

Related U.S. Application Data
(62) Division of application No. 10/313,595, filed on Dec. 6, 2002.

(51) Int. Cl. G11B 5/012

(52) U.S. Cl. 16/433

(57) ABSTRACT

A polymeric knob is made by a method wherein a unitary part, which comprises a hub, a bar extending across one end of the hub, and an indicator extending from one end of the bar, is molded and wherein a shell is molded over the unitary part, so as to cover portions of the bar, so as to surround portions of the hub, at the same end of the hub, and so as to allow portions of the indicator to remain exposed. One of the unitary part and the cover is molded with a recess or recesses and the other of the unitary part and the cover is molded with a boss or bosses fitting into the recess or recesses so as to interlock the unitary part and the body. A grip may be then molded over portions of the knob so as to allow the same portions of the indicator to remain exposed.

### CROSS-REFERENCE TO RELATED APPLICATION

This application is a division of U.S. patent application Ser. No. 10/313,595, which was filed on Dec. 6, 2002.

### TECHNICAL FIELD OF THE INVENTION

This invention pertains to a method of making a polymeric knob having a hub and a shell, such as an appliance knob or a control knob, and to a polymeric knob made by the method.

### BACKGROUND OF THE INVENTION

Heretofore, it has been known to mold a polymeric knob having a hub, which has a socket adapted to receive a non-circular shaft, and a shell, which surrounds portions of the hub, by molding the hub and the shell unitarily from a comparatively harder material. Moreover, it has been known, after the hub and the shell have been molded unitarily, to mold a grip or grips of a comparatively softer material over an exterior portion or exterior portions of the shell.

Molding the hub and the shell unitarily, as mentioned above, has shortcomings. Unwanted indentations, which are known as sink marks, can blemish the shell, as and where uneven thicknesses of the polymeric material used to mold the hub and the shell unitarily tend to cool unevenly, so as to cause localized shrinkage. Sink marks may remain apparent on the shell even if and after a grip has been molded over the shell, so as to cover such marks.

Polymeric appliance or control knobs of related interest, each having an indicator visible at or through an aperture in its shell, are exemplified in U.S. Pat. No. 3,619,594 to Morez, U.S. Pat. No. 5,050,269 to Engstrom et al., and U.S. Pat. No. 5,450,653 and No. 5,669,104 to Howie, Jr.

### SUMMARY OF THE INVENTION

This invention provides a method of making a polymeric knob, such as an appliance knob or a control knob, as discussed above. The method eliminates or minimizes sink marks, as discussed above.

In one contemplated mode for carrying out this invention, the method comprises steps of molding a unitary part, which comprises a hub, a bar extending across one end of the bar, and an indicator extending from one end of the bar, and molding a shell over the unitary part, so as to cover portions of the bar and so as to surround portions of the hub, at the same end of the hub. In an alternative mode for carrying out this invention, the method comprises similar steps, except that the indicator is omitted.

Preferably, in either mode, one of the unitary part and the cover is molded with a recess or recesses and the other of the unitary part and the cover is molded with a boss or bosses fitting into the recess or recesses so as to interlock the unitary part and the body. Preferably, in either mode, a grip or grips is or are molded over a portion or portions of the knob.

### BRIEF DESCRIPTION OF THE DRAWINGS

FIG. 1 is a partly schematic, perspective view illustrating a unitary part comprising a hub, a shell, and an indicator, as molded unitarily, in a single shot in a first cavity, in one contemplated mode for carrying out this invention.

FIG. 2 is a similar view of illustrating a shell, as molded over the unitary part, in a first shot in a second cavity, so as to allow portions of the indicator to remain exposed.

FIG. 3 is a similar view illustrating two grips, as molded over portions of the shell, in a second shot in the second cavity, so as to allow the same portions of the indicator to remain exposed.

FIG. 4, on a larger scale, is an axial cross-section of the unitary part, as taken along line 4-4 of FIG. 1, in a direction indicated by arrows. The indicator, which is molded unitarily with the hub and the bar, does not appear in FIG. 4.

FIG. 5, on a similar scale, is an axial cross-section of the unitary part and the shell, as taken along line 5-5 of FIG. 2, in a direction indicated by arrows.

FIG. 6, on a similar scale, is an axial cross-section of the unitary part and the shell, as taken along line 4-4 of FIG. 1, in a direction indicated by arrows. The indicator appears in FIG. 6.

FIG. 7, on a similar scale, is an axial cross-section of the hub and the shell, as taken along line 7-7 of FIG. 3, in a direction indicated by arrows.

FIG. 8 is a perspective view of a polymeric knob, which is similar to the polymeric knob illustrated in FIGS. 1 through 7 and which is made similarly, except that the indicator is omitted. In FIG. 8, the unitary part is illustrated fragmentarily, in broken lines below the shell and grips of the polymeric knob.

### DETAILED DESCRIPTION OF THE ILLUSTRATED MODES FOR CARRYING OUT THIS INVENTION

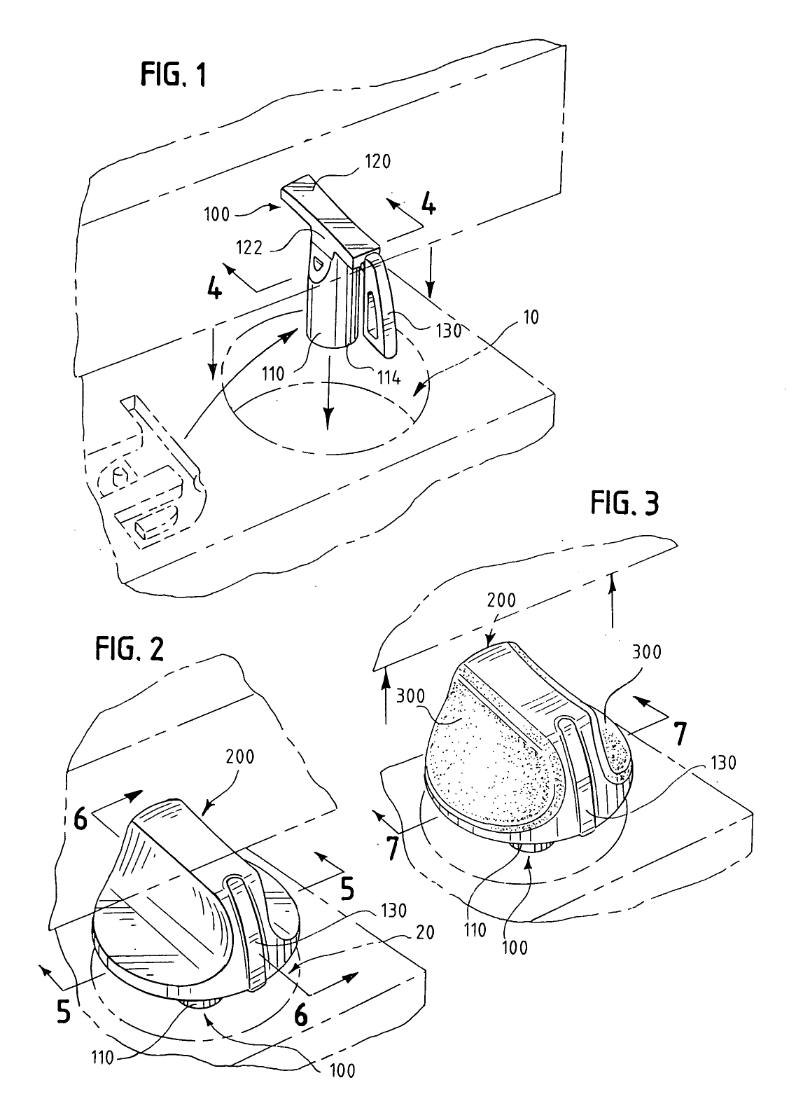

In FIGS. 1, 2, and 3, the steps of one contemplated mode for carrying out this invention are illustrated. In FIG. 1, the mating parts of a mold defining a first cavity 10 are illustrated schematically in broken lines and, in FIGS. 2 and 3, the mating parts of a mold defining a second cavity are illustrated schematically in broken lines.

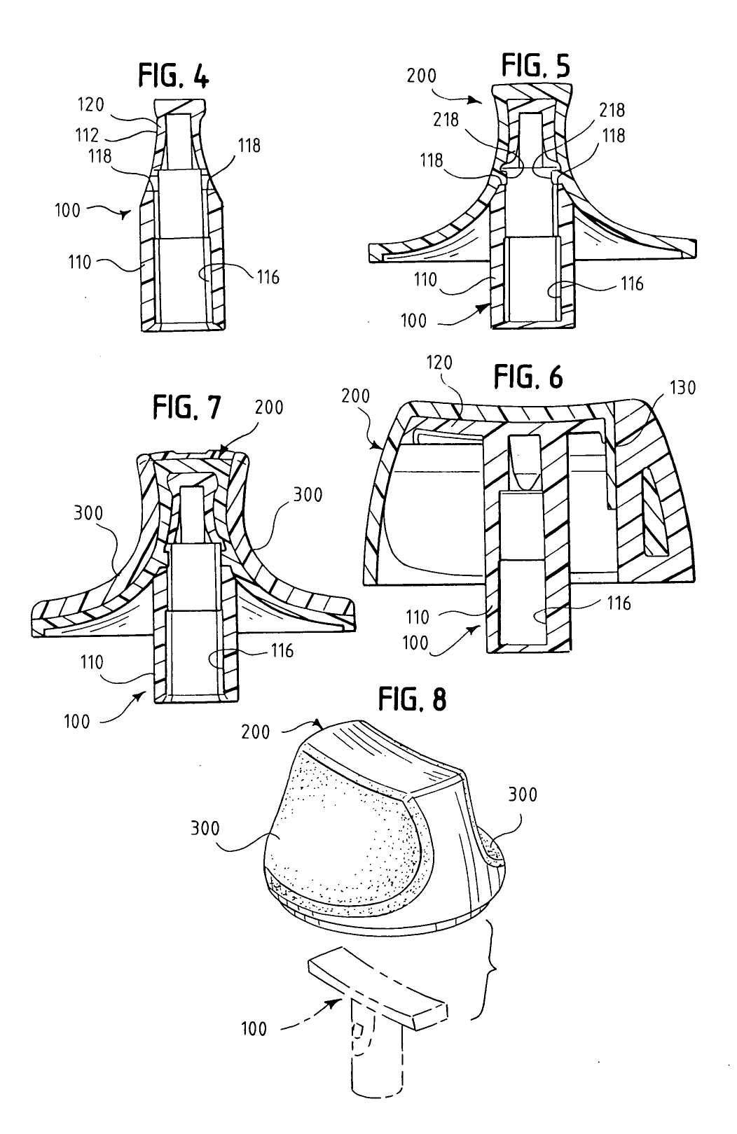

As illustrated in FIGS. 1 and 4, a unitary part 100 comprising a hub 110, which defines an axis, a bar 120, which extends diametrically across one end 112 of the hub 110, and an indicator 130, which extends from one end 122 of the bar 120, toward the other end 114 of the hub 110, and which is spaced radially from the hub 110, is molded from a polymeric material, in a single shot in the first cavity 10. As illustrated in FIG. 4, and also in FIGS. 5, 6, and 7, the hub 110 has a socket 116, which opens at the latter end 114 of the hub 110 and which is adapted to receive a non-circular shaft (not illustrated) of a valve or of a switch. Moreover, the unitary part 100 is molded with two recesses 118, which are opposed diametrically, in the hub 110, near the end 112 where the bar 120 extends diametrically across. Polypropylene, which is glass-filled and talc-filled, is a suitable material for the unitary part 100.

As illustrated in FIGS. 2, 5, and 6, a shell 200 is molded over the unitary part 100, from a polymeric material, in a first shot in the second cavity 20. The unitary part 100 is inset into the second cavity 20, after the unitary part 100 has cooled to ambient temperature, before the shell 200 is molded in the second cavity 20. The shell 200 is molded so as to cover portions of the bar 120, so as to surround portions of the hub 110, at the end 112 where the bar 120 extends diametrically across, and so as to allow portions of the indicator 130 to remain exposed. The shell 200 is molded with two bosses 218, which are opposed diametrically, each boss 218 fitting into and filling one of the recesses 118 of the unitary part 100, so as to interlock the unitary part 100 and the shell 200. Polypropylene, which is unfilled, is a suitable material for the shell 200.

As illustrated in FIGS. 3 and 7, two grips 300 of a polymeric material are molded, each over a diametrically opposed portion of the shell 200, so as to allow the same portions of the indicator 130 to remain exposed. Preferably, whereas the polymeric material of the unitary part 100 and the polymeric material of the shell 200 should be comparatively harder, the polymeric material of the grips 300 should be comparatively softer. A thermoplastic elastomer (TPE) is a suitable material for the grips 300.

Advantageously, because the shell 200 is molded over the unitary part 100, uneven thicknesses of the shell 200 are minimized. Thus, sink marks on the shell 200 are minimized so as to become negligible, if sink marks are not averted entirely.

1. A polymeric knob comprising a unitary part, which comprises a hub and a bar extending across one end of the hub, and a shell which covers portions of the bar and which surrounds portions of the hub where the hub adjoins the bar.

2. The polymeric knob of claim 1 wherein one of the unitary part and the cover has a recess or recesses and wherein the other of the unitary part and the cover has a boss or bosses fitting into the recess or recesses so as to interlock the unitary part and the body.

3. The polymeric knob of claim 1, which further comprises a grip or grips covering a portion or portions of the shell.

4. The polymeric knob of claim 2, which further comprises a grip or grips covering a portion or portions of the shell.

5. The polymeric knob of claim 1, which further comprises an indicator extending from one end of the bar, wherein the shell allows portions of the indicator to remain exposed.

6. The polymeric knob of claim 2, which further comprises an indicator extending from one end of the bar, wherein the shell allows portions of the indicator to remain exposed.

7. The polymeric knob of claim 3, which further comprises an indicator extending from one end of the bar, wherein the shell allows portions of the indicator to remain exposed.

8. The polymeric knob of claim 4, which further comprises an indicator extending from one end of the bar, wherein the shell allows portions of the indicator to remain exposed.

9. The polymeric knob of claim 1, wherein the unitary part comprises an indicator extending from one end of the bar, and wherein the shell allows portions of the indicator to remain exposed.

10. The polymeric knob of claim 2, wherein the unitary part comprises an indicator extending from one end of the bar, and wherein the shell allows portions of the indicator to remain exposed.

11. The polymeric knob of claim 3, wherein the unitary part comprises an indicator extending from one end of the bar, and wherein the shell allows portions of the indicator to remain exposed.

12. The polymeric knob of claim 4, wherein the unitary part comprises an indicator extending from one end of the bar, and wherein the shell allows portions of the indicator to remain exposed.
